(19) United States
(12) Patent Application Publication
(10) Pub. No.: US 2012/0175473 A1
(43) Pub. Date: Jul. 12, 2012

(54) TUBE HOLDER

(75) Inventor: Gary Fraze, Big Bear City, CA (US)

(73) Assignee: Duraflex Hong Kong Limited

(21) Appl. No.: 13/344,619

(22) Filed: Jan. 6, 2012

(30) Foreign Application Priority Data
Jan. 6, 2011 (CN) 201120014930.4

(51) Int. Cl. F16L 3/10

(52) U.S. Cl. 248/74.1

(57) ABSTRACT

The present invention relates to a tube holder comprising a main body part and a part for clamping a tube. The latter is a semi-enclosed structure, a first end of which is in rotary connection with the main body part and a second end of which buckles into the main body part. Since the tube holder herein only comprises two parts, it is simple in structure. After the tube has been placed into the part for clamping a tube, the part for clamping a tube of a semi-enclosed structure buckles into the main body part. As a result, the tube will not come off due to users' body shaking, representing excellent reliability. The tube can move in the part for clamping a tube as well. Moreover, the tube holder herein can be fixed onto the apparels or backpacks and further be regulated up and down according to uses' need.

### FIELD OF THE INVENTION

The present invention relates to accessories of apparel and backpack, more particularly, to a tube holder, in particular, to a tube holder used on the apparel, backpack or any other equipment for outdoor activities or sports.

### BACKGROUND OF THE INVENTION

On some apparels or backpacks, in particular, on the apparels, backpacks or any other equipment for outdoor activities or sports, a tube holder is needed to clamp a tube, such as a hydration tube. The existing tube holder generally comprises a plurality of components, thus being huge in volume and inconvenient for operation. Besides, the part for clamping a tube of the existing tube holder is generally an open structure. The tube is clipped inside through the opening. However, the opening is not closed, which results in that the tube easily comes off from the part for clamping a tube during the usage.

### SUMMARY OF THE INVENTION

The objective of the present invention is to provide a tube holder which is simple in both structure and usage, aiming at the above-mentioned drawbacks of the tube holder in the prior art; wherein, the tube can be fixed, moved up and down, easily removed and clamped reliably through the tube holder provided.

According to an aspect, a tube holder is provided, which comprising a main body part and a part for clamping a tube; the part for clamping a tube is a semi-enclosed structure, a first end of the part for clamping a tube is in rotary connection with the main body part and a second end of the part for clamping a tube buckles into the main body part.

In the tube holder of the present invention, both ends of the main body part are respectively provided with a part for receiving a webbing; each of the part for receiving a webbing is provided with at least one aperture for receiving a webbing.

In the tube holder of the present invention, each of the part for receiving a webbing is provided with a first aperture for receiving a webbing and a second aperture for receiving a webbing, wherein a width of the first aperture for receiving a webbing is larger than that of the second aperture for receiving a webbing.

In the tube holder of the present invention, the first end of the part for clamping a tube is provided with a tenon, and a part for receiving a tenon protruding from the main body part is arranged on the main body part correspondingly; both ends of the part for receiving a tenon are each provided with an aperture for receiving a tenon coordinating with the end of the tenon.

In the tube holder of the present invention, a notch for an entry of the end of the tenon into the aperture for receiving a tenon is arranged at both ends of the part for receiving a tenon.

In the tube holder of the present invention, the end of the tenon is provided with a guide inclined plane.

In the tube holder of the present invention, the second end of the part for clamping a tube is provided with a buckling part, and the main body part is provided with a buckling position which is adaptive with the buckling part.

In the tube holder of the present invention, an aperture in which the buckling position is arranged is provided on the main body part; wherein the buckling part is inserted into the aperture to buckle into the buckling position.

In the tube holder of the present invention, a groove for enhancing elasticity of the part for clamping a tube is arranged on an outside surface of the part for clamping a tube.

In the tube holder of the present invention, the part for clamping a tube is provided with a press position close to the second end of the part for clamping a tube; the press position is a concave on which a shook for avoidance of slippage is arranged.

In the tube holder of the present invention, both sides of the main body part are inner concaved cambers.

When implementing the tube holder of the present invention, the following advantageous effects can be achieved: since the tube holder of the present invention only comprises a main body part and a part for clamping a tube, it is simple in structure, low in cost and easy to be manufactured. The part for clamping a tube is presented as a semi-enclosed structure, wherein its first end is in rotary connection with the main body part and its second end buckles into the main body part. After the tube has been placed into the part for clamping a tube, the part for clamping a tube buckles into the main body part. As a result, the tube will not come off from the part for clamping a tube due to users' body shaking, representing excellent reliability. The tube can move in the part for clamping a tube as well. Accordingly, the tube holder of the present invention can be fixed onto apparels or backpacks, which can further be regulated up and down according to the users' need during activities after fixing.

### BRIEF DESCRIPTION OF THE DRAWINGS

The present invention will be further described with reference to the accompanying drawings and embodiments in the following. In the Figures:

FIG. 1 is a diagram for the first embodiment of the tube holder in the present invention;

FIG. 2 is an exploded view for the first embodiment of the tube holder in the present invention;

FIG. 3 is an exploded view in another angle for the first embodiment of the tube holder in the present invention;

FIG. 4 is a sectional view for the first embodiment of the tube holder in the present invention;

FIG. 5 to FIG. 8 are diagrams for the assembly of the first embodiment of the tube holder in the present invention;

FIG. 9 is an exploded view for the second embodiment of the tube holder in the present invention;

FIG. 10 is a diagram for the assembly of the second embodiment of the tube holder in the present invention;

FIG. 11 is an exploded view for the third embodiment of the tube holder in the present invention;

FIG. 12 is a diagram for the assembly of the third embodiment of the tube holder in the present invention;

FIG. 13 is an exploded view for the fourth embodiment of the tube holder in the present invention;

FIG. 14 is a diagram for the assembly of the fourth embodiment of the tube holder in the present invention;

FIG. 15 is an exploded view for the fifth embodiment of the tube holder in the present invention; and

FIG. 16 is a diagram for the assembly of the fifth embodiment of the tube holder in the present invention.

### DETAILED DESCRIPTION OF THE PREFERRED EMBODIMENT

To make the technical feature, objective and effect of the present invention be understood more clearly, now the specific implementation of the present invention is described in detail with reference to the accompanying drawings.

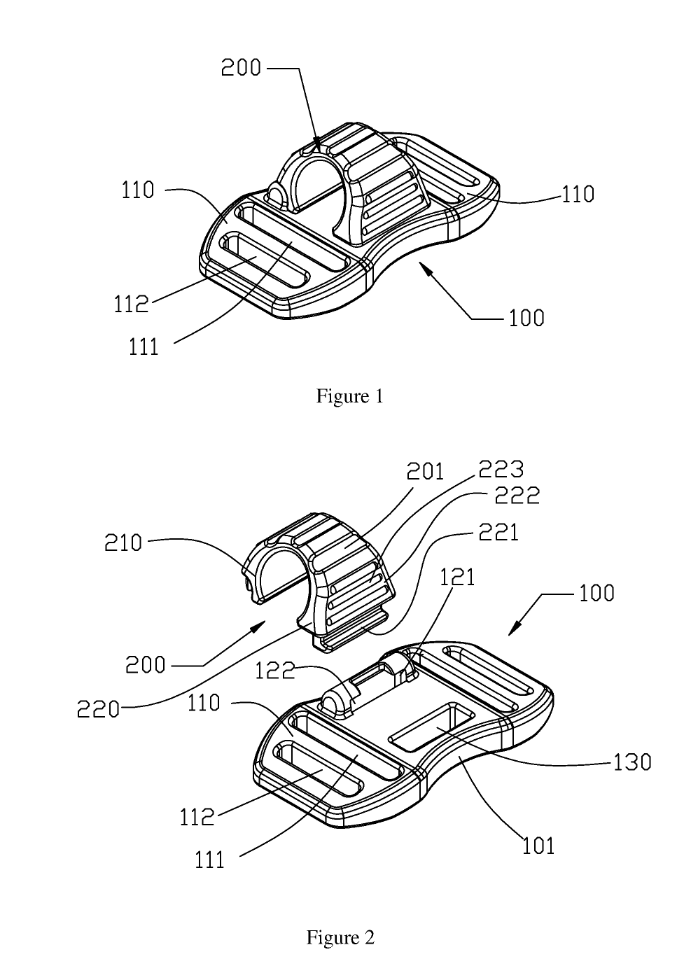

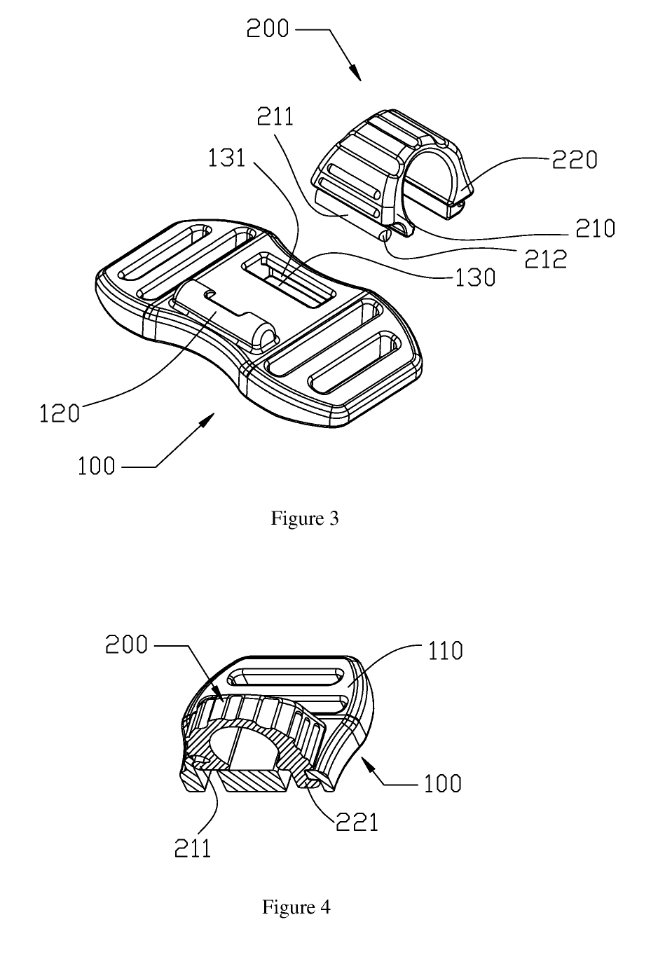

As shown in FIG. 1 to FIG. 4, a first embodiment for the tube holder of the present invention is disclosed. The tube holder comprises a main body part 100 and a part for clamping a tube 200.

Both ends of the main body part 100 are provided with a part for receiving a webbing 110, respectively. The webbing can pass through the part for receiving a webbing 110 to fix the main body part onto the apparel or backpack. In order to make the tube holder have better applicability, two apertures for receiving a webbing, i.e. one first aperture for receiving a webbing 111 and one second aperture for receiving a webbing 112, are provided in the part for receiving a webbing; wherein the width of the first aperture for receiving a webbing 111 is larger than that of the second aperture for receiving a webbing 112. The first aperture for receiving a webbing 111 is mainly applied in the situation where a wide webbing is employed, while the second aperture for receiving a webbing 112 is mainly applied in the situation where a narrow webbing is employed. Such tube holder is more humanized since such design of double apertures for receiving a webbing makes the tube holder be capable of meeting the needs of different webbings so as to facilitate the users to use and choose webbings. Meanwhile, in order to be more in line with the ergonomic design, the two sides of the main body part 100 are inner concaved cambers 101. It should be understood that only one aperture for receiving a webbing can be needed to be arranged on the part for receiving a webbing 110.

The part for clamping a tube 200 is a semi-enclosed structure which is substantially presented as a C-shape. A first end 210 of the part for clamping a tube 200 is in rotary connection with the main body part 100 and a second end 220 of the part for clamping a tube 200 buckles into the main body part 100. Specifically, the first end 210 of the part for clamping a tube 200 is provided with a tenon 211, and a part for receiving a tenon 120 protruding from the main body part 100 is arranged on the main body part 100 correspondingly. Besides, both ends of the part for receiving a tenon 120 are each provided with an aperture for receiving a tenon 121 coordinating with the end of the tenon 211. The tenon 211 wedges inside the part for receiving a tenon 120 to achieve the rotary connection between the part for clamping a tube 200 and the main body part 100. The part for receiving a tenon 120 protrudes from the main body part so that the assembly of the part for clamping a tube 200 with the main body part is easier. In order to facilitate the tenon 211 to go into the part for receiving a tenon 120, a notch 122 for the entry of the end of the tenon into the aperture for receiving a tenon 121 is arranged at both ends of the part for receiving a tenon 120. Further, a guide inclined plane 212 is arranged at the end of the tenon 211. It should be understood that the rotary connection between the part for clamping a tube 200 and the main body part 100 is not limited to the above-mentioned specific connecting way, while it can be any other conventional appropriate ways. For example, the rotary connection between the two is achieved by a hinge pin.

The second end 220 of the part for clamping a tube 200 is provided with a buckling part 221, and the main body part 100 is provided with a buckling position 131 which is adaptive with the buckling part 221. To avoid the release of the tube holder, an aperture 130 in which the buckling position 131 is arranged is provided on the main body part 100. In the embodiment, the buckling part 221 is a barb, the buckling position 131 is a stepped hook inside the aperture 130, and both of which coordinate with each other. When the second end 220 of the part for clamping a tube 200 buckles into the main body part 100, the buckling part 221 and the buckling position 131 can release from each other if only the second end 220 of the part for clamping a tube 200 is pressed from outside. In this way, it is ensured that the part for clamping a tube 200 will not be opened even when the tube is pulling by an external force, so that the tube is prevented from coming off from the tube holder effectively. It should be understood that any other conventional appropriate buckle structures can be employed for the buckling manner between the second end 220 of the part for clamping a tube 200 and the main body part 100.

In the embodiment, a groove 201 for enhancing the elasticity of the part for clamping a tube 200 is arranged on the outside surface of the part for clamping a tube 200 so as to enhance the elastic deformation capability of the part for clamping a tube 200. The number and the depth of the groove 201 are selected according to actual requirements. Any number and depth that can guarantee enough elastic deformation capability of the part for clamping a tube 200 are preferable. Meanwhile, the strength of the part for clamping a tube should be taken into consideration as well. In order to bring convenience for pressing the part for clamping a tube 200 so as to make the second end 220 of the part for clamping a tube 200 releases from the main body part 100, the part for clamping a tube 200 is provided with a press position 222 close to the second end of the part for clamping a tube 220. The press position 222 is a concave on which a shook for avoidance of slippage 223 is arranged. In this way, during pressing, the friction force can be increased to avoid slippage. It should be understood that any other structures for avoidance of slippage such as point projection can be employed to replace the shook for avoidance of slippage 233.

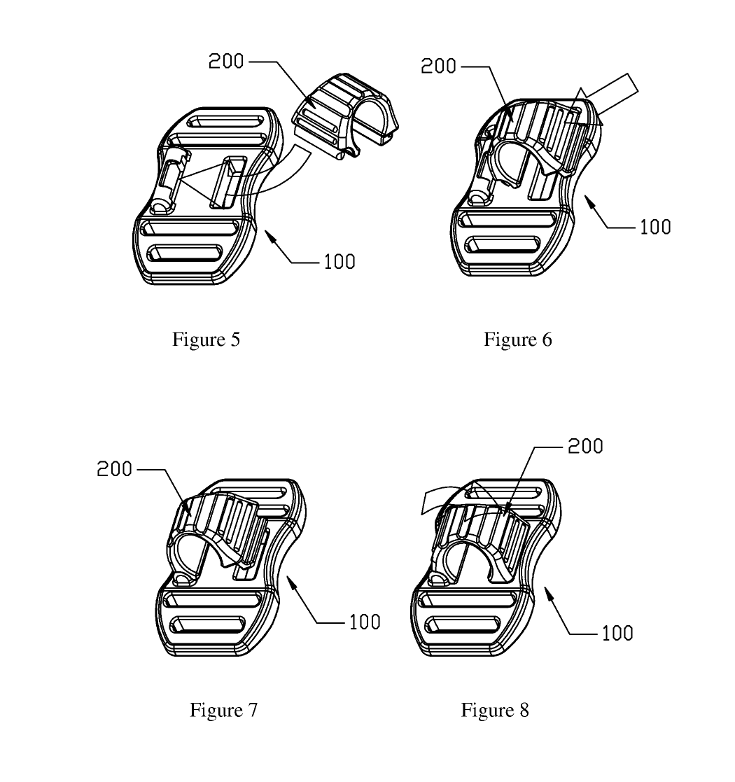

As shown in FIG. 5 to FIG. 8, the diagrams for the assembly of the tube holder in the first embodiment are disclosed. Along the direction indicated by the arrow, the tenon 211 at the first end 210 of the part for clamping a tube 200 is clipped into the part for receiving a tenon 120 after the two are in alignment with each other. In this way, the part for clamping a tube 200 is then mounted on the main body part 100 and it can further rotate with respect to the main body part 100. When fixing, the tube is firstly placed into the semi-enclosed structure of the part for clamping a tube 200. Then the part for clamping a tube 200 is turned to make the second end 220 of the part for clamping a tube 200 buckle into the main body part 100. After that, the tube is restricted between the part for clamping a tube 200 and the main body part 100. When the tube holder should be opened, it is only needed to press the press position 222 to make the second end 220 release from the main body part 100. Subsequently, the part for clamping a tube 200 is turned over so that the tube comes off from the tube holder.

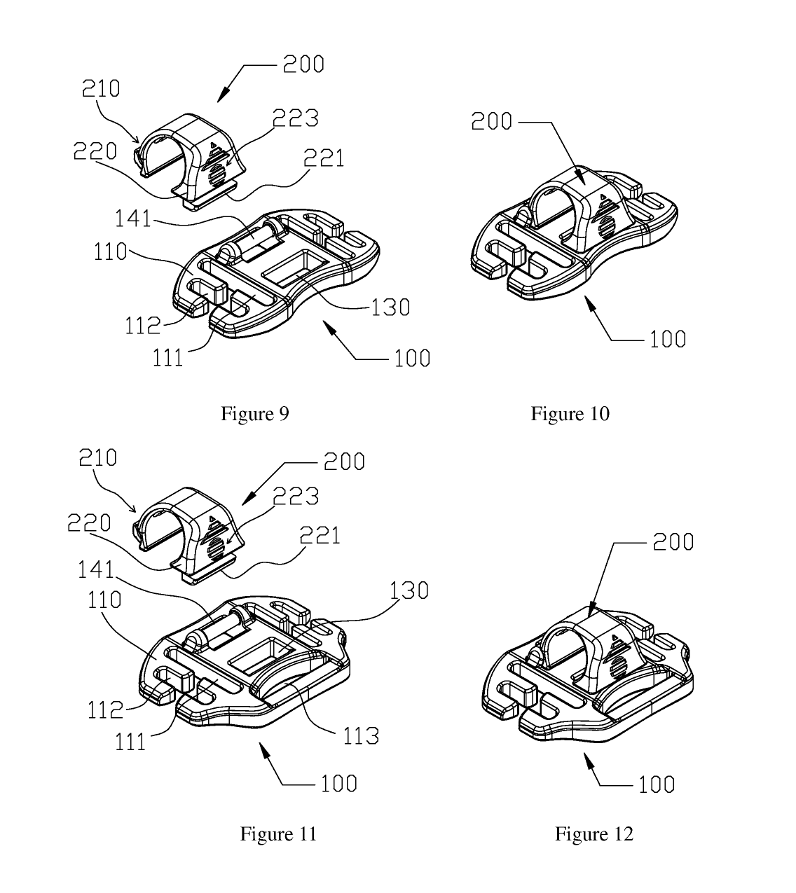

As shown in FIG. 9 and FIG. 10, they are the diagrams for the second embodiment of the tube holder in the present invention. The basic structure of the tube holder in the embodiment is the same as that of the tube holder in the first embodiment, which comprises a main body part 100 and a part for clamping a tube 200. Both sides of the main body part 100 are provided with a part for receiving a webbing 110, respectively. Distinct from the first embodiment, the first aperture for receiving a webbing 111 and the second aperture for receiving a webbing 112 of the part for receiving a webbing 100 are both provided with an opening 114. The arrangement of the opening 114 enables the webbing to be placed into or removed from the aperture for receiving a webbing at any moment, so as to make the tube holder be arranged onto or be removed from the webbing readily. The part for clamping a tube 200 is a semi-enclosed structure which is substantially presented as a C-shape. A first end 210 of the part for clamping a tube 200 is in rotary connection with the main body part 100 and a second end 220 of the part for clamping a tube 200 buckles into the main body part 100.

In this embodiment, the rotary connection between the first end 210 of the part for clamping a tube 200 and the main body part 100 is achieved through the following structure: a spindle 141 is formed on the main body part, and a hook part capable of hooking the spindle is disposed on the first end 100 of the part for clamping a tube 200. Thereafter, a detachable rotary connection can be formed between the two as the hook part hooks the spindle. The structure for the buckling of the part for clamping a tube 200 into the main body part 100 is the same as that in the first embodiment, which is not repeated herein. In the embodiment, the press position of the part for clamping a tube 200 is also provided with a shook for avoidance of slippage 223, while its structure is different from that in the first embodiment.

As shown in FIG. 11 and FIG. 12, they are the diagrams for the third embodiment of the tube holder in the present invention. Further improvement is made to the tube holder in the embodiment on the basis of the tube holder in the second embodiment. Specifically, an additional aperture for receiving a webbing 113 is arranged in front of the hole 130 of the main body part 100. Any other structures are the same as those in the second embodiment, which are not repeated here.

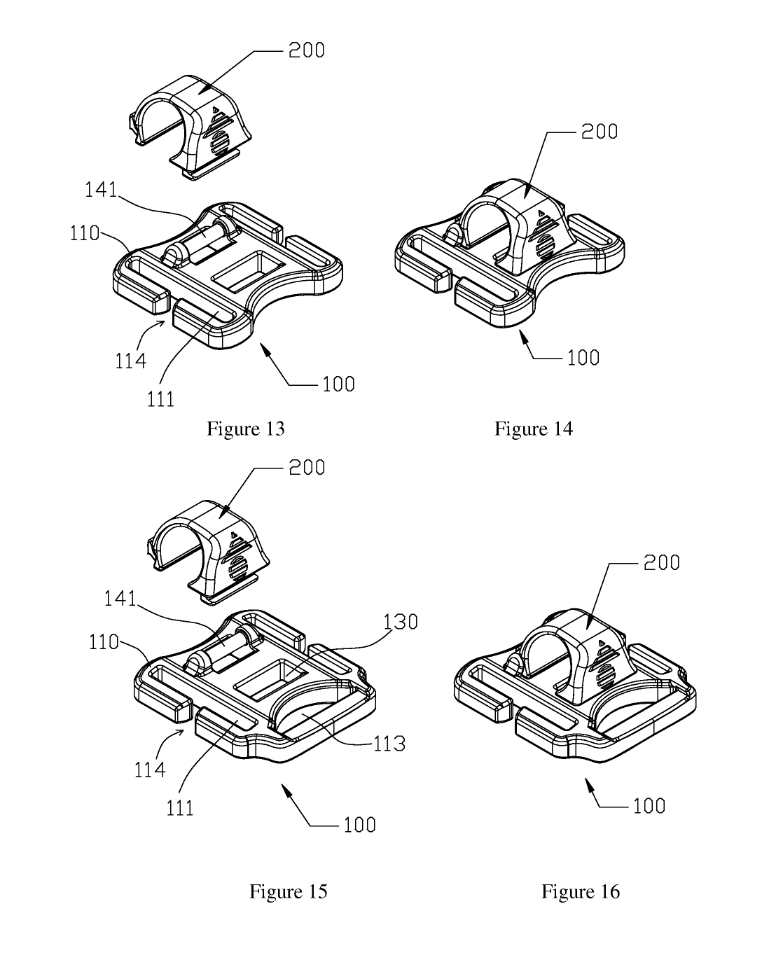

As shown in FIG. 13 and FIG. 14, they are the diagrams for the fourth embodiment of the tube holder in the present invention. Further improvement is made to the tube holder in the embodiment on the basis of the tube holder in the second embodiment. Specifically, only one aperture for receiving a webbing 111 is arranged in the part for receiving a webbing 110 of the main body part 100. The aperture for receiving a webbing 111 is provided with an opening 114. Any other structures are the same as those in the second embodiment, which are not repeated here.

As shown in FIG. 15 and FIG. 16, they are the diagrams for the fifth embodiment of the tube holder in the present invention. Further improvement is made to the tube holder in the embodiment on the basis of the tube holder in the third embodiment. Specifically, only one aperture for receiving a webbing 111 with an opening 114 is arranged in the part for receiving a webbing 110 of the main body part 100. Any other structures are the same as those in the third embodiment, which are not repeated here.

Since the tube holder of the present invention only comprises a main body part and a part for clamping a tube, it is simple in structure, low in cost and easy to be manufactured. The part for clamping a tube is presented as a semi-enclosed structure, wherein its first end is in rotary connection with the main body part and its second end buckles into the main body part. As a result, the tube will not come off from the part for clamping a tube due to users' body shaking, representing excellent reliability. The tube can move in the part for clamping a tube as well. Accordingly, the tube holder of the present invention can be fixed onto the apparels or backpacks, which can further be regulated up and down according to the uses' need during activities.

While the embodiments of the present invention are described with reference to the accompanying drawings above, the present invention is not limited to the above-mentioned specific implementations. In fact, the above-mentioned specific implementations are intended to be exemplary not to be limiting. In the inspiration of the present invention, those ordinary skills in the art can also make many modifications without breaking away from the subject of the present invention and the protection scope of the claims. All these modifications belong to the protection of the present invention.

1. A tube holder, comprising a main body part and a part for clamping a tube; wherein, the part for clamping a tube is a semi-enclosed structure, a first end of the part for clamping a tube is in rotary connection with the main body part and a second end of the part for clamping a tube buckles into the main body part.

2. The tube holder according to claim 1, wherein both ends of the main body part are respectively provided with a part for receiving a webbing; each of the part for receiving a webbing is provided with at least one aperture for receiving a webbing.

3. The tube holder according to claim 2, wherein each of the part for receiving a webbing is provided with a first aperture for receiving a webbing and a second aperture for receiving a webbing, wherein a width of the first aperture for receiving a webbing is larger than that of the second aperture for receiving a webbing.

4. The tube holder according to claim 1, wherein the first end of the part for clamping a tube is provided with a tenon, and a part for receiving a tenon protruding from the main body part is arranged on the main body part correspondingly; both ends of the part for receiving a tenon are each provided with an aperture for receiving a tenon coordinating with the ends of the tenon.

5. The tube holder according to claim 4, wherein a notch for an entry of the ends of the tenon into the aperture for receiving a tenon is arranged at both ends of the part for receiving a tenon.

6. The tube holder according to claim 5, wherein the end of the tenon is provided with a guide inclined plane.

7. The tube holder according to claim 1, wherein the second end of the part for clamping a tube is provided with a buckling part and the main body part is provided with a buckling position which is adaptive with the buckling part.

8. The tube holder according to claim 7, wherein an aperture in which the buckling position is arranged is provided on the main body part; wherein the buckling part is inserted into the aperture to buckle into the buckling position.

9. The tube holder according to claim 1, wherein a groove for enhancing elasticity of the part for clamping a tube is arranged on an outside surface of the part for clamping a tube.

10. The tube holder according to claim 1, wherein the part for clamping a tube is provided with a press position close to the second end of the part for clamping a tube; the press position is a concave on which a shook for avoidance of slippage is arranged.

11. The tube holder according to claim 1, wherein both sides of the main body part are inner concaved cambers.
